(19) United States
(12) Patent Application Publication
(10) Pub. No.: US 2004/0224065 A1
(43) Pub. Date: Nov. 11, 2004

(54) Pet food treat and method of making same

(76) Inventors: Joseph P. Markham, Arvada, CO (US); Thomas Kieth Martin, Amarillo, TX (US)

Correspondence Address: SHERIDAN ROSS PC, 1560 BROADWAY, SUITE 1200, DENVER, CO, 80202

(21) Appl. No.: 10/798,008

(22) Filed: Mar. 10, 2004

Related U.S. Application Data
(63) Continuation-in-part of application No. 10/431,490, filed on May 6, 2003.

(51) Int. Cl. A23K 1/175

(52) U.S. Cl. 426/516; 426/619

(57) ABSTRACT

A food product and method of making the same are disclosed. The food product is preferably made of a processed Sorghum grain, and preferably from hybrids of Milo. The grain is subjected to decortication and extrusion. Additives may be provided to flavor or otherwise nutritionally enhance the processed Milo. The additives are added prior to extrusion. The food product may be made from other grains or tubers by removing the starch and then using the starch to extrude the food product. A final food product may be achieved by further processing of the extruded grain. Further processing may include molding, baking, or pelletizing.

### CROSS REFERENCE TO RELATED APPLICATIONS

This application claims priority from and is a continuation-in-part of U.S. Ser. No. 10/431,490 filed on May 6, 2003 entitled “Pet Food Treat and Method of Making Same”, the disclosure of which is incorporated herein by reference in its entirety.

### FIELD OF THE INVENTION

The present invention relates to the production of food products, and more particularly to pet food teats, and methods of making the food products by extrusion of suitable grain.

### BACKGROUND OF THE INVENTION

Pet foods for dogs and cats are typically prepared as either canned or dry meal type rations. These rations are commonly formulated from a combination of proteinaceous and farinaceous materials. Farinaceous materials are derived from various cereal grains, and proteinaceous materials are derived from either vegetable protein sources or from meat and/or meat by-products. It is also well known to add various nutritional supplements to both meal and canned rations such as vitamins, minerals, etc.

Dry meal type rations typically have a cereal-like texture and a low moisture content around 10%. Dry rations can be produced to provide a completely balanced diet for an animal. Dry rations also have excellent storage characteristics, thus permitting use of relatively inexpensive packaging techniques.

Canned rations have a meat-like texture and a high moisture content. The elevated moisture content of such canned foods requires thermal processing in sealed containers to obtain a commercially sterile product, thereby adding considerably to product costs. Once a can is opened, it must be quickly consumed since the high moisture content is conducive to supporting microbial growth, and hence the product will deteriorate rapidly unless stored in refrigerated conditions.

A third type of animal food has become popular more recently which can be characterized as intermediate moisture products, typically having a moisture content in the range of about 15 to 30%. For these intermediate products, in order to prevent microbial decomposition, such products must be specially processed through pasteurization, or must be chemically treated with various preservatives, and/or must be packaged in sealed containers which are commercially sterilized. Another approach to preserving these intermediate moisture products is to disperse an aqueous phase of water-soluble solids throughout the product, the soluble solids being principally sugar at a level high enough to exert a bacteriostatic effect sufficient to stabilizing animal food. Like canned rations, these intermediate products are more expensive to produce because of the need to specially package or preserve the products.

Conventional methods for producing dry rations involve either extrusion or palletizing techniques wherein the dry rations are formed in a desired size and shape for a particular animal. The mixed farinaceous and/or proteinaceous sources of dry rations in extrusion are subjected to the action of the extruding machine which mixes the materials, and exposes them to heat and elevated pressures thereby converting the materials to a flowable semi-liquid substance. The temperature of the mixed materials passing through the extruder is typically above 212° F. The heated materials are expelled through die in the extruder device to atmospheric pressure, so that the heated moisture within the mixture flashes to steam causing the material to expand into a cellular mass. The cellular mass is then cut into pieces of a desired length, dried to a stable moisture content, and then treated with a flavored coating or with a chemical coating to preserve the product. The materials used to make most dry rations are also mixed prior to extrusion with various chemical preservatives to enhance the stability of the ration, and/or to assist in extrusion of the material. Although dry rations have a relatively long shelf life, depending upon the particular type of cereal grain or protein source used in the extrusion, there is still a need to preserve the ration with some type of chemical preservative.

It is well known to use various types of cereal grains in an extrusion process to produce feed having characteristics reflective of the particular type of cereal grain which is used. One reference which discloses a method of making a pet snack food, to include disclosure of various of types of cereal grains which may be used to make pet food an extrusion process is the U.S. Pat. No. 5,894,029.

Another reference disclosing animal feed which is produced through an extrusion process, and composed of proteinaceous and/or farinaceous material, is the U.S. Pat. No. 4,143,169.

Among the cereal grains used for making pet food or pet treats, corn and wheat are perhaps the most well known. Other types of grains may be added in smaller portions to the larger portions of wheat or corn in those dry food rations which are made by extrusion.

As pet food and pet food treats continue to develop in sophistication based upon a market which is increasingly conducive to sale of diversified pet products, new techniques for producing the pet foods also continue to develop. Despite pet food product diversification, basic food production still includes the need to provide healthy, inexpensive, and easily packaged food products.

Sorghum Vulgare is perhaps the oldest domesticated plant known to man. It has been hybridized since early Egyptian years and is very diversified in its hybrid state. Varieties commonly referred to as Milo have few if any uses other than for animal feed. Sorghum Vulgare is widely used in the United States as a less expensive feed grain in comparison to corn or wheat. Other parts of the world, particularly Africa and Asia, use Sorghum for flour and human food. In the United States, Milo as a particular group of hybrids, is a very different type of cereal grain as compared to Sorghum which is grown in other parts of the world. In the United States, a need was established early on for developing a feed grain that was resistant to various growing problems. These problems included drought, insect infestations, migrating birds, and high winds. As a result of these factors, Milo has evolved into special hybrids which are able to withstand the various growth problems. Accordingly, the type of Sorghum available particularly in the United States is a very successful grain, but is not well suited for any use other than standard feed grain.

### SUMMARY OF THE INVENTION

One object of the present invention is to provide an animal food product which utilizes a grain which is inexpensive, easily extrudable, and has high nutrition value.

Another object of the present invention is to provide an animal food product which may readily accept a flavoring or additive in the extrusion process thereby eliminating the need for a separate processing step in incorporating the additive.

It is yet another object of the present invention to provide an animal food product which may be varied in its texture, weight, size and density based upon the moisture content of the materials which are extruded to make the food product.

It is yet another object of the present invention to provide an animal food product which has an extended shelf life, and does not require chemical preservatives or special packaging in order to maintain the extended shelf life.

It is yet another object of the present invention to provide a process for making an animal food product wherein the process may be easily adapted to produce animal food products of a desired size, density, weight, nutritional value and flavorings.

The products of the present invention comprise a matrix preferably manufactured from Milo seeds which at least have been decorticated resulting in berry and berry particulates which may then be exposed directly to extrusion. Additives may be added to the processed Milo prior to extrusion. The additives may be nutritional supplements and/or specific flavorings which enhance the nutritional value and palatability of the product.

In accordance with the method of the present invention, a desired stock of Milo grain is chosen, and the selected grain is cleaned and sized. In the cleaning operation, a destoning operation may be incorporated to remove any hard material of like size and shape, such as small stones or pebbles. The Milo grain is then decorticated in one of several known methods of grain decorticating. The decortication removes the husks or hulls of the Milo seeds. Optionally, the remaining berry and berry particulates are then passed through a scourer to remove the fatty endogerm portion of the berries. De-fatting of the berries can enhance the ability of the Milo grain to be extruded because fat can act as a lubricant in extrusion thereby degrading the ability of an extruder to produce a consistent food product. The next step in production of the food is an extrusion wherein a bake-type extruder is used under preferred heat and pressure ranges. The product produced in the extrusion process can be defined as a matrix of Milo which may carry an additive. One advantage of extrusion is that it also serves to kill bacteria and other microbes thereby helping to provide a product of increased shelf life.

After extrusion, the matrix may be considered in its final form, with the exception of curing which may be required. The extruded matrix may be light and puffy, or more dense having a crunchy, nugget type consistency, such as in pellet form. For the denser extruded matrix, it may directly cut into desired pellet sizes as the matrix exits the extruder die. The pellets then may be stored for further processing.

The matrix may be further processed to create a final product. One way in which the matrix may be further processed is to immediately transfer it into a mold cavity wherein the matrix or extrudate is molded into a desired shape. For example, a tube of a desired diameter can directly interconnect the matrix exiting the die of the extruder with a cavity of a mold whereby the matrix is injected into the mold cavity. Alternatively, the tube can be one which allows some expansion of the matrix as it leaves the die of the extruder, yet still maintaining the matrix under pressure so that it maintains a flowable state, thereby ensuring that the matrix can be injected into the mold cavity. Then, the matrix within the mold cavity would be allowed to “set” into the desired form, thereby creating a final product of a desired shape. The molds can be heated or cooled to achieve a product having desired hardness and texture.

Another option in further processing of the matrix or extrudate after extrusion would be to cure and dry the matrix, and then at some later time introduce the matrix into a mold thereby creating a final product of a desired shape. For this particular option, the matrix may have to be reworked prior to delivering the matrix to an injection molding machine. For example, the matrix could be crushed and/or sheared to place it in a powdered form, and a plasticizer, glycerin, or other ingredients could be added to place the matrix in a form that allows creation of a final product with a desired hardness or texture. Examples of plasticizers include gelatin, tapioca, gluten, starch, or carrageenan. If the matrix was already placed in pellet form as mentioned above, then rework may be unnecessary because the pelletized matrix could be directly added to an injection molding machine.

Yet another option in creating a final product from the matrix would be to rework the matrix to create a fine powder, thereby having a flour-type consistency. Water could be mixed with the fine powder to provide the matrix in a dough-like form. The dough-like matrix could be pushed or pressurized through a die and cut into desired shapes. The shaped matrix can then be baked or flashed to create a final product.

Placing the matrix in a pellitized form can occur through the extrusion wherein the matrix is relatively small and dense. As mentioned above, the size of the matrix which result from extrusion depends upon moisture content, heat, and pressure. Accordingly, a pellitized form of the matrix can be achieved without further rework. On the other hand, a pellitized form of the matrix can also be achieved by the subsequent rework process wherein the matrix is crushed or ground, and then the crushed/ground matrix is then introduced into a pellitizing machine. Of course, if it is known that the matrix needs to be in the pellitized form when the Milo grain is first processed, then it would be preferable to create the pellitized matrix directly from the extrusion.

If the matrix is to be further processed by a subsequent molding or baking process, it has been found that use of a denser matrix with a higher moisture content provides best results.

As mentioned above, one additional step that may be required in the process is to cure the product, preferably at a room temperature with a minimum of 60% air moisture content, until the product is stable. This curing step is affected by the type of additives which may be added to the matrix.

In accordance with another aspect of the present invention, other types of grains or even tubers may be used to produce a desired food product wherein the method of production requires an additional step of removing the starch from the grain/tuber. Other grains which may be selected include corn, wheat, rice, and others. The extracted starch is the portion of the grain/tuber which is used, and the remaining portions are discarded. Typically, for starch based products which are extruded, flavorings are not added until after the extrusion process thereby increasing the complexity and overall cost of producing the food product. With the use of other types of grains, this later flavor adding step can be eliminated by directly adding the flavorings prior to extrusion. For most other grain types, an additional processing step is required which is to remove the starch from the rest of the grain or tuber, the removed starch typically being in a powdered form. The starch may be removed in any well-known starch removal process to produce a basic starch powder.

Other features and advantages of the present invention will become apparent from a review of the following detailed description, taken in conjunction with the drawing, which illustrates the preferred embodiments of the method of the present invention.

### BRIEF DESCRIPTION OF THE DRAWING

FIG. 1 is a flowchart showing the basic steps used in processing Milo grain to produce a food product according to the present invention.

### DETAILED DESCRIPTION

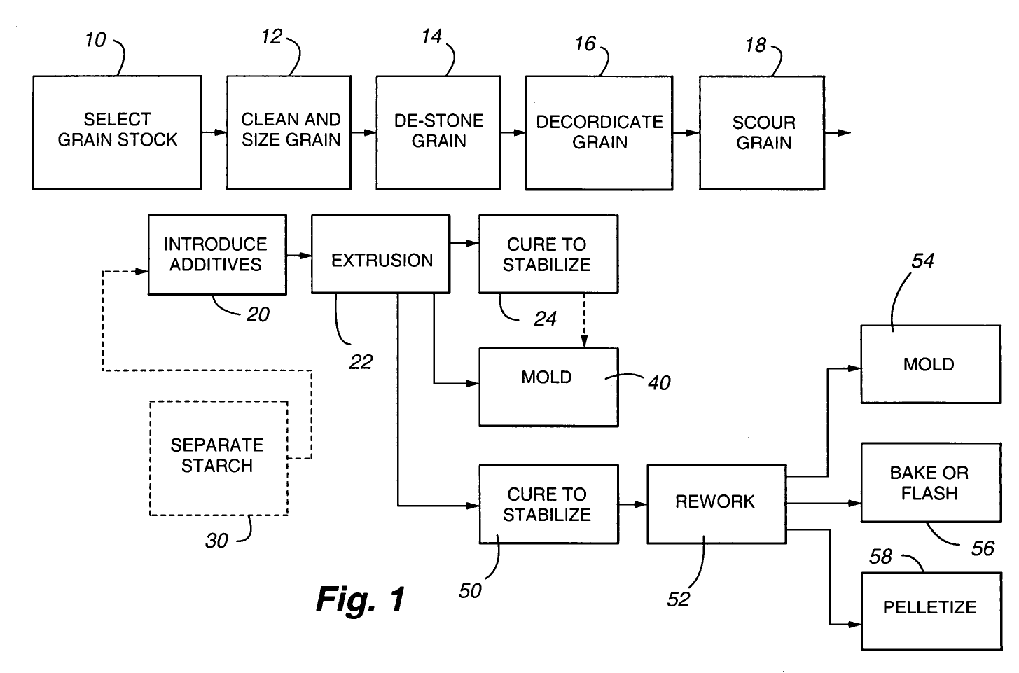

Referring to FIG. 1, the basic steps in the methods of making the food product of the present invention are illustrated. In a first step at block 10, a pure stock of grain Milo is selected. Although there is no specific hybrid of Milo which is required for the product and method of the present invention, it is desirable to choose a single pure stock grain because this pure stock grain is advantageous in creating repeatability of the extrusion process. Each hybrid of Milo may contain its own unique protein sequence. Even small differences in protein sequence may alter a particular extrusion. Therefore, by deliberately selecting grains with the same desired protein sequence, extrusion can be more reliably repeated.

The next step in the process shown at block 12 is to clean and size the Milo grain. Standard cleaning and sizing equipment may be used to process the grain at this step wherein air/water streams may be used to clean the grain, and the grain may be passed through various sieves to obtain the desired grain size. There is no required grain size for the present invention, and it has been found in testing that many different grain sizes can be used with good extrusion results.

Shown at block 14 is a next step in the process which is an optional destoning operation to remove stones or other similar sized objects which may still remain in the grain after cleaning and sizing. Although a destoning operation is shown as a separate optional step, destoning can be incorporated within a cleaning and sizing operation at step 12. Therefore, it shall be understood that although destoning is shown separately in the flowchart, is not necessarily required to be a separate step in the method. Any well known destoning operation can be used.

The next step in the process is shown at block 16 which is the decortication of the Milo grain. Any one of several methods of usual grain decortication may be used to decorticate the Milo. For example, two references which disclose methods for decorticating Milo and which have been found to be particularly effective are the methods described in the U.S. Pat. Nos. 5,713,526 and 5,820,039. These two references are incorporated herein by reference for purposes of disclosing basic methods by which Milo grain may be decorticated. Another common method of decortication involves swirling the grain in a cyclone at a high rate of speed against a rasping surface. The grain contacts the rasping surface and breaks into pieces wherein the lighter, less dense hull is separated from the berry. Yet another common method is to expose the Milo grain to a stream of high-pressure water which separates the berry from the hull of the grain.

The next step in the method is shown at block 18 which is an optional step of scouring the grain to remove fatty oils or lipids. There are two distinct advantages for de-fatting the Milo grain at this stage. The first is enhancing the consistency and repeatability of the extrusion process because fats in the grain tend to act as a lubricant through the extrusion die, thereby degrading extruder operation. The second advantage is the production of a more nutritional pet food which has less fat content. Well-known grain scouring processes may be used to remove the fatty endogerm from the Milo grain. Although scouring is discussed as a step in the basic method, it shall be understood that scouring is not necessarily required as it may be desirable in some circumstances to have certain levels of fat within the food product. Additionally, scouring may be eliminated to simplify the overall food production process.

The next step in the method is shown at block 20 which involves introduction of a desired additive(s) to the processed Milo. The Milo and additive(s) may be referred to as a grain mix. For pet food, there are a number of additives which are contemplated within the present invention which may be advantageous for pet food or pet treats. Examples of these additives include, but are not limited to, additives in the form plant or animal protein sources. For example, one particularly advantageous additive is liver meal which is known to be preferred by almost all dogs. To create a pet treat incorporating liver meal having a light and puffy texture, the mixture ratio of the Milo to the liver meal would be from about 7:1 to about 12:1 by weight. Preferably, the ratio of the Milo to the liver meal is about 9:1 by weight. In order to provide an extrudable mixture, it is preferable to maintain the Milo at or around 16% moisture, and the liver meal at or around 20% moisture. Alternatively, to produce a pet treat which is not as puffy but rather is denser, smaller, and has more of a crunchy, nugget consistency, the ratio of Milo to liver meal would be from about 1:2 to about 5:2 by weight. Preferably, the ratio of Milo to liver meal would be about 3:2 by weight. For this denser product, the moisture content prior to extrusion is preferably about 18-22%. Other additives which may be used include vitamins, minerals or other nutritional supplements. These additives can be added at this step in prescribed amounts which do not pose a health risk to the animals even in the event that a particular animal would consume a large number of the treats at a single time. Yet additional types of additives which are also contemplated include medications, peanuts, fish meal, poultry meal, dried fruits or vegetables, flavored oils or other concentrated liquid flavorants, tubers, and even other types of grain such as wheat or bran. Milo is a grain which readily accepts a variety of additives, and there is little segregation or separation between the Milo grain and the additives in the extruded food product.

It may be desirable to mechanically mix the grain mix in a bin which will then meter the grain mix into the extrusion machine. Mechanical mixing helps to ensure uniform dispersion of the additive. It is also necessary to add water to the decorticated grain in order to create the grain mix with the necessary moisture content. It has been found in testing that Milo has approximately 10-12% moisture content prior to processing. In order to optimize extrusion, it has been found through testing that a moisture content of about 16% is preferable.

The next step in the method is illustrated at block 22 which involves extrusion of the Milo grain mix. Through testing, it has been found that extrusion can be achieved utilizing a bake-type extruder which exposes the grain mix to heat in the range of about 325° F. to about 400° F., and pressure in the range of about 1500 psi to about 2,000 psi. The particular shape of the die used in the extruding machine may be adapted to produce a food product of a desired shape. One example of a die could include the use of a die having a round shaped hole with a diameter of approximately 0.120 inch. The cutting mechanism used in the extruding machine can be adapted for cutting the extrudate to a length of about three-quarters inch. For a grain mix which is extruded having an overall moisture content of approximately 16%, the resulting extruded product has a light, puffy and cellular consistency at moisture contents between about 5-8%. As moisture content is increased in the grain mix, the resulting food product is smaller and denser as the product will experience less expansion during extrusion. For example, a food product having a more nugget-like consistency can be produced which is still crunchy, but does not have the puffy, cellular consistency. Temperature and pressure can also be adjusted within the extrusion process to produce a food product which is of a desired size, shape and density.

After extrusion, there are a number of options in providing a final product. If it is desired to simply sell the Milo matrix after extrusion, then one additional step shown at block 24 contemplates curing the food product to thereby stabilize the product prior to shipping. Depending upon the texture and consistency of the food product produced, i.e., one that is very puffed or more dense, a certain amount of curing may be required to allow the food product to reach equilibrium in terms of moisture content. Thus, the cured product could be light and puffy, or could be more dense such as in pellet form.

Another option after extrusion is to provide a molded product, shown at molding step 40. A tubular member could directly interconnect the point at which the matrix exits the die of the extrusion device with a mold cavity. This intermediate tube could be sized to allow some or no expansion of the matrix as it exits the die of the extrusion device. In any event, the product must be maintained in somewhat of a flowable or molten state which allows the product to flow into the mold cavity. Once the product enters the mold, it is allowed to set and cool for a prescribed time, the molded product is then removed and is ready for shipping. The product may experience baking in the mold due to heat and pressure added during extrusion and heat added to the mold. Additionally, some curing may be required after the molding step 40 prior to shipping the molded product.

Yet another option in providing a final product would be to cure the extruded matrix at step 50, and then sometime later, rework the cured matrix to provide either a molded product, a baked/flashed product, or a pellitized product. As shown in FIG. 1, the matrix would be reworked, as shown at block 52. For example, the matrix could be crushed, sheared, pulverized, ground, milled, powdered, or combinations thereof. To produce a molded product as shown at step 54, the matrix could be introduced into a hopper, the hopper then metering a desired amount of matrix into a crushing/shearing device, and the matrix then being forced into a mold under heat and pressure such as by a feed screw. As mentioned above, a plasticizer or other ingredients may be added to the matrix during rework. The reworked matrix in powdered form may also be baked or flashed to provide a final product as shown at step 56. As necessary, the powdered matrix may receive additional liquid to increase the moisture content wherein a dough like consistency is achieved for baking or flashing. Baking or flushing can be achieved by use of a standard oven. Alternatively, the matrix may be reworked to place the matrix in a pellitized form, as shown at block 58, assuming the matrix was not already pellitized in extrusion. Thus, the matrix as cured at step 50 could then be introduced to a pellitizing machine to produce pellets.

In accordance with another aspect of the present invention, other types of grains may be used to produce the food product. For example, corn, wheat and rice can also be used as the basic grains which make the matrix of the present invention. With these grains; however, an additional processing step is required to remove the starch from the remaining part of the grain. The removed starch is typically in powder form. In their natural state, these other grains are very difficult to extrude successfully, and therefore, the part of the grain to be extruded, the amylose starch, is separated from the whole grain prior to extrusion. Milo also contains starch, best characterized as an amylose-pectin starch. However, after decortication, Milo is readily extrudable without also having to first isolate the starch component of the grain.

In addition to grains in which starch has been removed for use in extrusion, it is also contemplated within the present invention to use the starch extracted from tubers, such as potatoes. As with the Milo grain, these extracted starches must also receive the required amount of water to raise the moisture content to a desired level corresponding to the texture and density of the final product.

Referring again to FIG. 1, the additional step of separating the starch is shown at block 30 in dotted lines. Additives are added to the starch in step 20, and then the mixture is extruded at step 22.

In accordance with another aspect of the invention, the grain mix can also be mixed with a gelatin prior to extrusion thereby increasing the hardness of the resulting extruded food product.

There are a number of advantages of utilizing a Milo matrix as a food product. First, there is the relatively low cost of producing such a food product as the processing steps for creating the Milo matrix can be achieved within a relatively simple grain processing method. Milo grain is a relatively high protein, low fat grain which is both palatable and easily digestible by both humans and animals. Processed Milo is generally hydrophobic, therefore very stable in all climates and storing conditions. Accordingly, the food product produced may be packaged and sold within packaging which does not have to be sealed or otherwise specially treated. For example, large bins of the Milo food product can be directly incorporated within retail locations where a consumer measures a desired amount of the food product to be purchased and then places the product into a plastic or paper bag. A Milo food product made by the above-described methods requires no chemical additives to preserve the product for extended shelf life. Another advantage as mentioned above is the ability to produce food products which have a variety of densities. Lighter, puffier products as well as denser, crunchier products may be easily produced. By varying the temperature and pressure of the extrusion, or adjusting the moisture content, the particular size and density of the product can be chosen. For example, extruding the Milo grain mix through a die having a round opening of about 0.120 of an inch in diameter and at about 16% moisture content, can produce a product having a width/diameter of approximately three-quarters inch, which then can also be cut to a desired length. Increasing the moisture to about 18% has been shown to produce a product having a width/diameter of approximately one-half inch. During the extrusion process, the heat and pressure advantageously kill bacteria and other undesirable microorganisms thereby increasing the shelf life of the product. Also during extrusion, the additives become evenly mixed within the decorticated grain thereby producing an evenly dispersed mixture. Accordingly, the additive is evenly distributed throughout each batch of the extruded pet food product in contrast to many other types of pet treats, into which flavorings or additives are incorporated by electrostatic processes which simply coat the exterior surfaces of the product. These electrostatic processes are less desirable because the flavoring/additive is more easily separated from the product. By creating a well dispersed mixture through the extrusion process of the present invention, the desired additive is better delivered to the consuming animal. The Milo matrix may also be reworked after extrusion by directly molding the extrudate, or by allowing the extrudate to cure, and then rework the matrix in a subsequent molding or baking/flashing process. Thus, large quantities of the matrix can be stored during an intermediate period, and then as required, final products may be made from the matrix at a later time. Because of the increased shelf life of the Milo matrix, temporarily storing the matrix after extrusion provides yet another option and ultimately providing a product based upon market demands, which can be seasonal thereby providing a food producer great flexibility as to when final product should be packaged and shipped.

The above invention has been described with respect to preferred embodiments; however, other changes and modifications may be made within the spirit and scope of the invention.

What is claimed is:

1. A method of producing a food product comprising the steps of:
cleaning a desired hybrid of Milo grain;
decorticating the grain;
introducing an additive creating a grain mix;
extruding the grain mix; and
introducing the grain mix to a mold to create a food product.

2. A method, as claimed in claim 1, wherein:
moisture content of the grain mix prior to extrusion is about 16%.

3. A method, as claimed in claim 1, wherein:
said at least one additive is selected from the group consisting of plant and animal protein sources.

4. A method, as claimed in claim 1, wherein:
said at least one additive is selected from the group consisting of medications, vitamins, minerals, liver meal, peanuts, fish meal, poultry meal, dried fruit, dried vegetables, flavored oils, concentrated liquid flavorants, grains other than Milo, tubers and combinations thereof.

5. A method, as claimed in claim 1, further comprising the step of:
scouring the grain prior to extrusion to remove fatty endogerm of the grain.

6. A method, as claimed in claim 1, further comprising the step of:
destoning the grain prior to the step of decorticating the grain.

7. A method, as claimed in claim 1, further comprising the step of:
altering the moisture content of the grain mix to thereby vary the density of an extrudate produced by the extrusion.

8. A method, as claimed in claim 1, further comprising the step of:
curing the food product after molding.

9. A method, as claimed in claim 1, wherein:
increasing the moisture content of the grain mix prior to extrusion produces a smaller, denser extrudate, and lessening the moisture content of the grain mix produces a larger, less dense extrudate.

10. A method, as claimed in claim 1, wherein:
moisture content prior to extrusion is in the range of about 16% to about 22%.

11. A method of producing a food product comprising the steps of:
selecting a desired grain;
cleaning the grain;
decorticating the grain;
removing the starch from the grain;
combining the removed starch with an additive creating a starch mix;
extruding the starch mix to produce an extrudate; and
molding the extrudate.

12. A method, as claimed in claim 11, wherein:
said at least one additive is selected from the group consisting of plant and animal protein sources.

13. A method as claimed in claim 11, wherein:
said additive is selected from the group consisting of medications, vitamins, minerals, liver meal, peanuts, fish meal, poultry meal, dried fruit, dried vegetables, flavored oils, and concentrated liquid flavorants, grains other than Milo, tubers, and combinations thereof.

14. A method of producing a food product comprising the steps of:
selecting a desired hybrid of Milo grain;
decorticating the grain;
introducing an additive creating a grain mix;
extruding the grain mix to create an extrudate;
curing the extrudate to stabilize the extrudate;
reworking the cured extrudate, said reworking selected from the group consisting of crushing, shearing, pulverizing, grinding, milling, and combinations thereof; and
introducing the reworked extrudate to a mold to create a final food product.

15. A method, as claimed in claim 14 wherein:
moisture content of the grain mix prior to extrusion is about 16%.

16. A method, as claimed in claim 14, wherein:
said at least one additive is selected from the group consisting of plant and animal protein sources.

17. A method, as claimed in claim 14, wherein:
said at least one additive is selected from the group consisting of medications, vitamins, minerals, liver meal, peanuts, fish meal, poultry meal, dried fruit, dried vegetables, flavored oils, concentrated liquid flavorants, grains other than Milo, tubers, and combinations thereof.

18. A method, as claimed in claim 14, further comprising the step of:
scouring the grain prior to extrusion to remove fatty endogerm of the grain.

19. A method, as claimed in claim 14, further comprising the step of:
destoning the grain prior to the step of decorticating the grain.

20. A method, as claimed in claim 14, further comprising the step of:
altering the moisture content of the grain mix to thereby vary the density of an extrudate produced by the extrusion.

21. A method of producing a food product comprising the steps of:
selecting a desired hybrid of Milo grain;
decorticating the grain;
introducing an additive creating a grain mix;
extruding the grain mix to create an extrudate;
curing the extrudate to stabilize the extrudate;
reworking the cured extrudate, said reworking selected from the group consisting of crushing, shearing, pulverizing, grinding, milling, and combinations thereof; and
baking the reworked extrudate to create a final food product.

22. A method, as claimed in claim 21, wherein:
moisture content of the grain mix prior to extrusion is about 16%.

23. A method, as claimed in claim 21, wherein:
said at least one additive is selected from the group consisting of plant and animal protein sources.

24. A method, as claimed in claim 21, wherein:
said at least one additive is selected from the group consisting of medications, vitamins, minerals, liver meal, peanuts, fish meal, poultry meal, dried fruit, dried vegetables, flavored oils, concentrated liquid flavorants, grains other than Milo, tubers, and combinations thereof.

25. A method, as claimed in claim 21, further comprising the step of:
scouring the grain prior to extrusion to remove fatty endogerm of the grain.

26. A method, as claimed in claim 21, further comprising the step of:
destoning the grain prior to the step of decorticating the grain.

27. A method, as claimed in claim 21, further comprising the step of:
altering the moisture content of the grain mix to thereby vary the density of an extrudate produced by the extrusion.

28. A method of producing a food product comprising the steps of:
selecting a desired grain;
cleaning the grain;
decorticating the grain;
removing starch from the grain;
combining the removed starch with an additive creating a starch mix;
extruding the starch mix to produce an extrudate;
curing the extrudate to stabilize the extrudate;
reworking the cured extrudate, said reworking selected from the group consisting of crushing, shearing, pulverizing, grinding, milling, and combinations thereof; and
molding the reworked extrudate to form a final product.

29. A method of producing a food product comprising the steps of:
selecting a desired grain;
cleaning the grain;
decorticating the grain;
removing starch from the grain;
combining the removed starch with an additive creating a starch mix;
extruding the starch mix to produce an extrudate;
curing the extrudate to stabilize the extrudate;
reworking the cured extrudate, said reworking selected from the group consisting of crushing, shearing, pulverizing, grinding, milling, and combinations thereof; and
baking the reworked extrudate to form a final product.

30. A method of producing a food product comprising the steps of:
selecting a desired hybrid of Milo grain;
decorticating the grain;
introducing an additive creating a grain mix;
extruding the grain mix to create an extrudate;
curing the extrudate to stabilize the extrudate;
reworking the cured extrudate, said reworking selected from the group consisting of crushing, shearing, pulverizing, grinding, milling, and combinations thereof; and
pelletizing the reworked extrudate to create a final food product.

31. A method, as claimed in claim 30, wherein:
moisture content of the grain mix prior to extrusion is about 16%.

32. A method, as claimed in claim 30, wherein:
said at least one additive is selected from the group consisting of plant and animal protein sources.

33. A method, as claimed in claim 30, wherein:
said at least one additive is selected from the group consisting of medications, vitamins, minerals, liver meal, peanuts, fish meal, poultry meal, dried fruit, dried vegetables, flavored oils, concentrated liquid flavorants, grains other than Milo, tubers, and combinations thereof.

34. A method, as claimed in claim 30, further comprising the step of:
scouring the grain prior to extrusion to remove fatty endogerm of the grain.

35. A method, as claimed in claim 30, further comprising the step of:
destoning the grain prior to the step of decorticating the grain.

36. A method, as claimed in claim 30, further comprising the step of:
altering the moisture content of the grain mix to thereby vary the density of an extrudate produced by the extrusion.

37. A method of producing a food product comprising the steps of:
selecting a desired grain;
cleaning the grain;
decorticating the grain;
removing starch from the grain;
combining the removed starch with an additive creating a starch mix;
extruding the starch mix to produce an extrudate;
curing the extrudate to stabilize the extrudate;
reworking the cured extrudate, said reworking selected from the group consisting of crushing, shearing, pulverizing, grinding, milling, and combinations thereof; and
pelletizing the reworked extrudate to form a final product.
